(19) United States
(12) Patent Application Publication
(10) Pub. No.: US 2018/0005511 A1
(43) Pub. Date: Jan. 4, 2018

(54) DETECTING EXIT OF A PERSON FROM A ROOM

(71) Applicant: 9SOLUTIONS OY, Oulu (FI)

(72) Inventor: Sami HERRALA, Oulu (FI)

(73) Assignee: 9SOLUTIONS OY, Oulu (FI)

(21) Appl. No.: 15/634,599

(22) Filed: Jun. 27, 2017

(30) Foreign Application Priority Data
Jun. 29, 2016 (EP) 16176776.9

(51) Int. Cl. G08B 21/22

(52) U.S. Cl. CPC G08B 21/22

(57) ABSTRACT

There is provided a device and a method for detecting exit of a person from a room, the device comprising: means for detecting door opening and closing; movement detection means for detecting movement in the room; and a processing circuitry configured to initiate processing of measurement data from the movement detection means as a response to detecting the door closing, and to cause an output of a message concerning the processing of said measurement data.

### TECHNICAL FIELD

The present invention relates to determining presence of a person in a room or some other closed space. More particularly the present invention relates to detecting exit of a person from a room.

### BACKGROUND

Monitoring movement of a person, such as a patient or an aged person, is increasing in popularity. For example, it may beneficial to employ methods and devices which provide information whether or not the person has left his/her to apartment or room. Such information may be valuable for relatives or nursing staff and may decrease a need for manual labour. US 2007/0176760 discloses a method for determining whether a person suffering dementia has left their flat unaccompanied. The method includes identifying an event indicating opening of the front door of the flat, determining whether flat was occupied by more than one person prior to the door opening, determining whether there is inactivity in the flat following the door opening and sending a notification to a communications terminal of a carer if the flat was occupied by only one person and if there is inactivity in the flat. A system for performing the method is also described.

EP 1906370 discloses a system having a local central processing unit, sensor devices and an alarm system. The central processing unit has a truth table containing given logical signal sequences. The processing unit changes from an operating condition into a warning condition when deviating a succession of signals received from the sensor devices to the truth table. The signal sequences are combined into events and time windows are assigned to the given signals and/or events. The processing unit changes into the warning condition when holding off the signal and/or event within an assigned time window. An independent claim is also included for a method for the monitoring and signalling of a person in helpless situations. In EP 1906370, the sensor devices may comprise a door switch at the door, and a motion detector behind the interior side of the door. When the person leaves the apartment, the sensor devices may provide the following signal sequence: motion signal on the interior side of the door, open the door signal and closing the door signal. Further, there would not be any further motion signals from the interior side of the door. Thus, the sequence of the different signals can be used to detect whether the person is leaving the room or entering the room.

The advantages of the above described systems and methods, i.e. systems and methods of US 2007/0176760 and EP 1906370, is that it may be known whether or not a monitored person is in a specific monitored space, such as a flat or a room. However, there are also some disadvantages in the described solutions. For example, in US 2007/0176760 the motion detecting sensors are constantly on and transmit indication when movement is detected. For example, in EP 1906370 motion is detected prior to detecting the door open/door close signals. The system may thus unnecessarily use power (e.g. battery) when the motion data is constantly monitored. Also, signalling load may increase as the motion detecting sensor of EP 1906370 transmits indication each time when movement is detected.

Therefore, the purpose of the present invention may be to provide a novel solution to the above mentioned problems of the known systems.

### BRIEF DESCRIPTION

According to an aspect, there is provided a device for detecting exit of a person from a room, the device comprising: a casing; a detector for detecting door opening and closing, said detector being enclosed by the casing; movement detector for detecting movement in the room, the casing further enclosing the movement detector such that movement detector and the detector for detecting door opening and closing are both situated in the same device; and a processing circuitry configured to initiate processing of measurement data from the movement detector as a response to detecting the door closing, and to cause an output of a message concerning the processing of said measurement data.

According to an aspect, there is provided a method for detecting exit of a person from a room, the method comprising: detecting, by a device using a switch enclosed by a casing of the device, a door closing event; as a response to the detecting the door closing event, initiating processing of measurement data from one or more movement detection sensors enclosed by said casing of the device; and causing an output of a message concerning the processing of said measurement data.

Some embodiments are described in dependent claims. One or more examples of implementations are set forth in more detail in the accompanying drawings and the description below. Other features will be apparent from the description and drawings, and from the claims.

By implementing means to detect door opening and closing and a movement detection means into a same device, the complexity of the system may be decreased. The device further comprises a processing circuitry for processing data. The processing circuitry starts processing measurement data from the movement detection means when door closing is detected. Thus, there may not be a need to constantly process the measurement data from the movement detection means. This may save power and decrease signalling in the system.

One further benefit of the present invention relates to false alarms. In the known systems, an alarm is typically outputted when a door switch indicates that door is opened and then closed. Thus, if a person, for example, only peeks through the doorway, a false alarm may be performed. Each of these false alarms may cause a check call or a recce. This inevitably may increase costs. The co-operation between the means for detecting the door opening and closing, and the movement detection means may at least reduce the number of false alarms, and thus inevitably reduce costs.

Further, the present invention provides a solution in which only one device may be needed to detect the exit of a person from a room. Thus, there may not be a need to have a complicated system with a plurality of sensors. Therefore, for example, installation and production costs may be reduced. For example, the device of the present system may work with one power source and thus maintenance and care of the system may become easier compared with systems utilizing a plurality of sensors each having a separate power source.

Further, using a plurality of motion detection sensors around the room, as in the known systems, may increase amount of false detection. For example, a pet may cause a false movement detection. However, in the present solution using the single device for the movement detection may decrease these false detections.

Therefore, the present solution provides a novel method and a novel device which solve the problem of how to time decrease power consumption and signalling load of the system. Further, the present solution may decrease complexity and cost of the system, and may also provide a system which produces less false alarms.

### BRIEF DESCRIPTION OF DRAWINGS

In the following embodiments will be described in greater detail with reference to the attached drawings, in which

FIG. 1 illustrates an example system to which embodiments of the invention may be applied;

FIG. 2 illustrates a device for detecting exit of a person from a room according to an embodiment;

FIG. 3 illustrates a flow diagram according to an embodiment;

FIGS. 4A to 4D illustrate signal diagrams according to some embodiments;

FIG. 5 illustrates a block diagram according to an embodiment;

FIGS. 6A to 6B illustrate sonic embodiments;

FIGS. 7A to 7D illustrate some embodiments; and

FIG. 8 illustrates a flow diagram according to an embodiment.

### DETAILED DESCRIPTION OF SOME EMBODIMENTS

The following embodiments are exemplifying. Although the specification may refer to “an”, “one”, or “some” embodiment(s) in several locations of the text, this does not necessarily Mean that each reference is made to the same embodiment(s), or that a particular feature only applies to a single embodiment. Single features of different embodiments may also be combined to provide other embodiments.

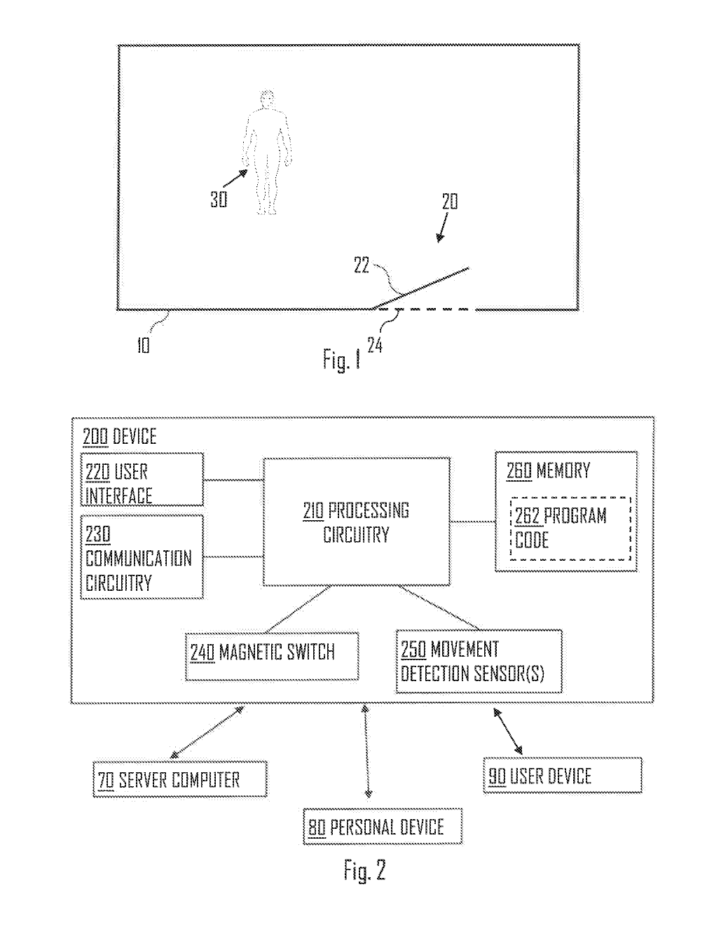

FIG. 1 illustrates an example system to which embodiments of the invention may be applied. Referring to FIG. 1, the system may comprise one or more persons 30. The purpose of the system may be to detect if the person leaves or exits the room 10. The room 10 needs to be understood in a broad sense. For example, the room 10 may refer to any space having encircling walls, a roof or ceiling and a floor. Further, the room 10 has a door 20 or similar means for exiting and entering the room. Thus, for example, the room 10 may refer to a hallway, living room, apartment, patient room, and the like. In some embodiments, the embodiments of the invention may be applied to determining whether or not the user has exited the room 10 via a window. Thus, the door 20 should also be understood in a broad sense as operation of the window and the door may be somewhat or substantially similar. The door 20 may comprise a door leaf 22 and a doorway 24, wherein the door leaf 22 may be used to open or close the doorway 24 via which the user 30 may enter or exit the room 10.

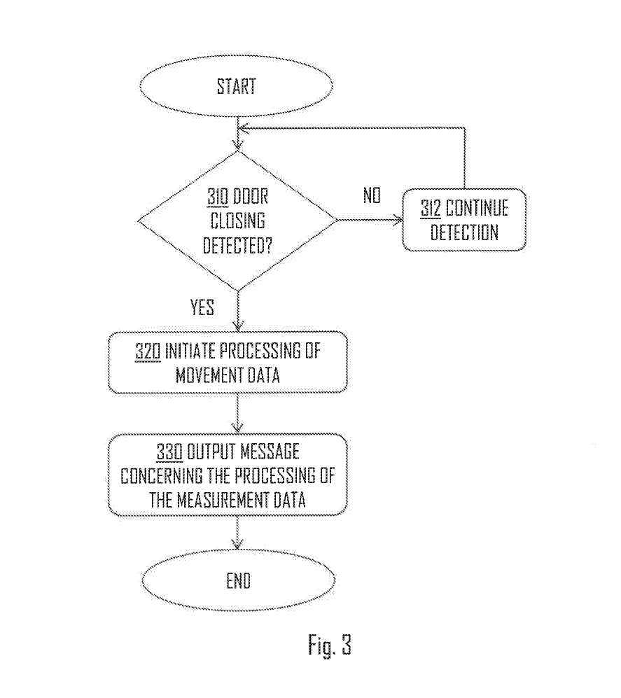

Let us now look closer on a device 200 of FIG. 2 which may be used to provide the above described benefits. Referring to an embodiment of FIG. 2, the system of FIG. 1 comprises the device 200.

In an embodiment, the system of FIG. 1 comprises the device 200 and the server computer 70.

In an embodiment, the system of FIG. 1 comprises the device 200, the server computer 70, the personal device 80, and/or the user device 90.

The server computer 70 and the device 200 may be communicatively coupled with each other. Similarly, the personal device 80 and the device 200 may be communicatively coupled with each other. Similarly, the user device 90 and the device 200 may be communicatively coupled with each other. Similarly, the personal device 80 and the user device 90 may be communicatively coupled with each other. Similarly, the personal device 80 and/or the user device 90 may be communicatively coupled with the server computer 70.

The server computer 70 may refer to any computing device performing server operations, such as cloud server or a physical server computer. The server computer 70 may be comprised in a network, such as a local network or a cloud network. Thus, the server computer 70 may be connected via Internet access, cellular network and/or local area network to one or more of the devices 200, 80, 90.

The personal device 80 may refer to a portable device that is carried and/or worn by the person 30. For example, the personal device 80 may be a safety phone (e.g. mobile phone) or safety bracelet. The personal device 80 may have communication capabilities, such as a wireless communication circuitry (e.g. cellular communication, Bluetooth, ANT+, ZigBee, Wireless Local Area Network (WLAN) and/or Near Field Communication (NFC)), Cellular communication may utilize 2G, 3G, 4G, 5G, Long Term Evolution (LTE), and/or LTE-Advanced (LTE-A) technologies, for example. Cellular communication may require a physical or a virtual Subscriber Identification Module (SIM), similar which are used in mobile phones of today. In an embodiment, the personal device 80 is configured to enable bidirectional and/or unidirectional communication with the server computer 70. For example, an alarm signal may be transmitted by the personal device 80 via the server 70 to an external device, such as the user device 90 used by a caretaker. For example, a voice call performed between the personal device 80 and an external device, such as the user device 90.

The user device 90 may be a portable handheld device, such as a mobile phone, tablet, or a smart phone. Thus, the user device 90 may have similar communication capabilities as the personal device 80 (e.g. cellular communication, Bluetooth, ANT+, ZigBee, MAN and/or NFC). In an embodiment, the user device 90 is a radio tag. The radio tag may provide, for example, Bluetooth, ANT+, ZigBee, WLAN, and/or NFC communication capabilities.

At this point it needs to be noted that Bluetooth may refer to communication according to the Bluetooth specifications. For example, Bluetooth communication may comprise Bluetooth Smart (also referred to as Bluetooth Low Energy (BLE)) communication. Similarly, the ZigBee communication may refer to communication according to the relevant ZigBee standards.

In an embodiment, the system of FIG. 1 comprises a mesh network. The mesh network may be a wireless mesh network. The mesh network may be communicatively connected to the server computer 80. The mesh network may be communicatively connected to one or more of the devices 80, 90, 200, in an embodiment, the mesh network comprises the device 200. In an embodiment, the mesh network comprises the device 200 and one or more radio nodes. In an embodiment, the mesh network comprises a plurality of radio nodes. The mesh network may be used, for example, to provide location information for a user device, such as the user device 90. The location information may be based on determining location based on radio signals transmitted by one or more of said radio nodes. For example, the radio nodes may transmit Bluetooth or ZigBee signals which may be received by the user device. The user device may determine its location based on signal strength and/or on the basis which signal(s) the user device is able to detect, for example. On the other hand, the user device may transmit signals to the mesh network. The mesh network may determine the location information based on the received signals by one or more of said radio nodes.

Let us now discuss in more detail about the device 200 with reference to FIG. 2. The device 200 may be for detecting exit of the person 30 from the room 10. The device 200 may comprise means 240 for detecting door opening and closing; a movement detection means 250 for detecting movement in the room 10; and a processing circuitry 210 configured to initiate processing of measurement data from the movement detection means 250 as a response to detecting the door closing, and to cause an output of a message concerning the processing of said measurement data. Thus, as the processing of said measurement data (also referred to as movement data) initiates only after detecting the door closing, power consumption and signaling may be reduced. Also, as the means 240 and the movement detection means 250 are comprised in the same device, the complexity and cost of the system may be reduced. For example, in an embodiment, the device 200 comprises a casing, wherein said casing at least partially encloses said means 240 (i.e. switch or detector for s detecting door opening and closing) and movement detection means 250 (i.e. movement detector). Thus, the casing may enclose the door opening/closing detector 240 and movement detector 250. Naturally, the casing may comprise, at least in some embodiments, one or more openings for enabling the different switches and detectors to operate accordingly. However, as the detectors 240, 250 may be located within the same casing, this decrease the signaling load of the system. Furthermore, the processing circuitry 210 may be enclosed by the casing. It is also possible that the casing forms a body of the device 200 that encloses one or more elements of the device 200.

Further, the detecting the door closing may cause a state of the processing circuitry 210 to change from a first state to second state, wherein in the first state the processing circuitry 210 does not process said measurement data from the movement detection means 250, and wherein in the second state the processing circuitry 210 initiates or starts to process said measurement data.

In an embodiment, the device 200 further comprises a user interface 220 enabling interaction with the apparatus 200. The user interface 220 may comprise physical button(s), display(s), touch-screen(s), speaker(s) and/or microphone(s) to name a few.

In an embodiment, the device 200 further comprises a communication circuitry 230. The communication circuitry may be a wireless communication circuitry 230 for enabling wireless communication with an external device, such as the server computer 80, the mesh network, the personal device 80, and/or the user device 90.

In an embodiment, the device 200 comprises at least one processor and at least one memory 260 comprising a computer program code 262, wherein the at least one memory 260 and the computer program code 262 are configured, with the at least one processor, to perform functions of the device 200. For example, the at least one processor and the memory with the computer program code 262 may be used to perform operations of the processing circuitry 210. In an embodiment, the processing circuitry 210 comprises one or more processors.

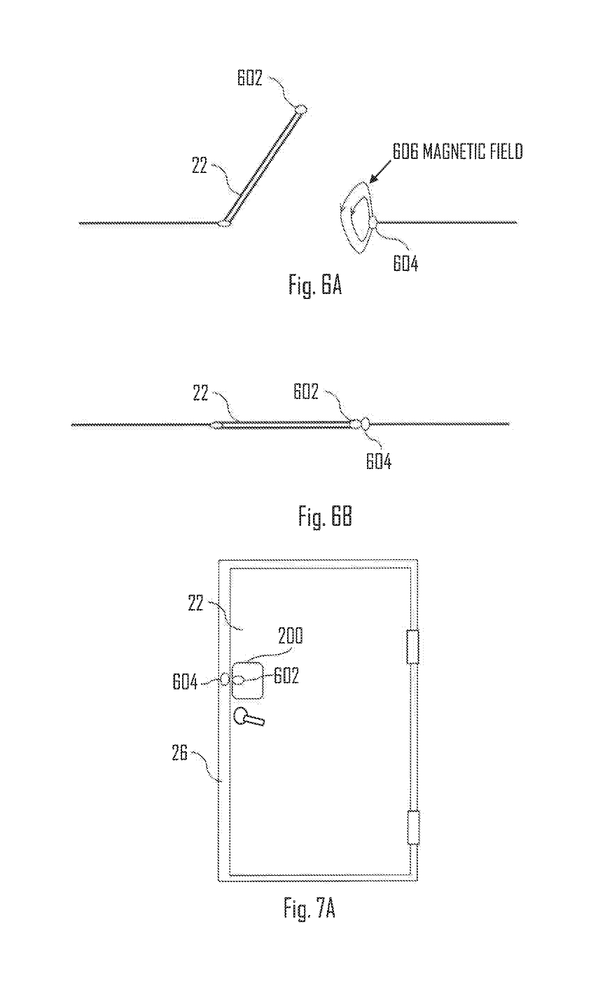

Still referring to FIG. 2, the means 240 may comprise a magnetic switch for detecting the door opening and door closing. Other such switches or detectors may be used. For example, the detecting the door opening and closing may be based on detecting electrical current. For example, when the door is dosed a closed circuit may be formed (e.g. one part in the door leaf and one in the frame of the door). The closed circuit may break when the door is opened. On the other hand, a proximity sensor may be used to detect the door opening and closing. For example, the proximity sensor may be used to detect that the door leaf is close to the door frame or wall. These means for detecting door opening and closing 240 need to be understood as examples and the implementation may be different depending on the use case. However, the magnetic and electrical in switch are discussed later in more detail with reference to FIGS. 6A to 6B.

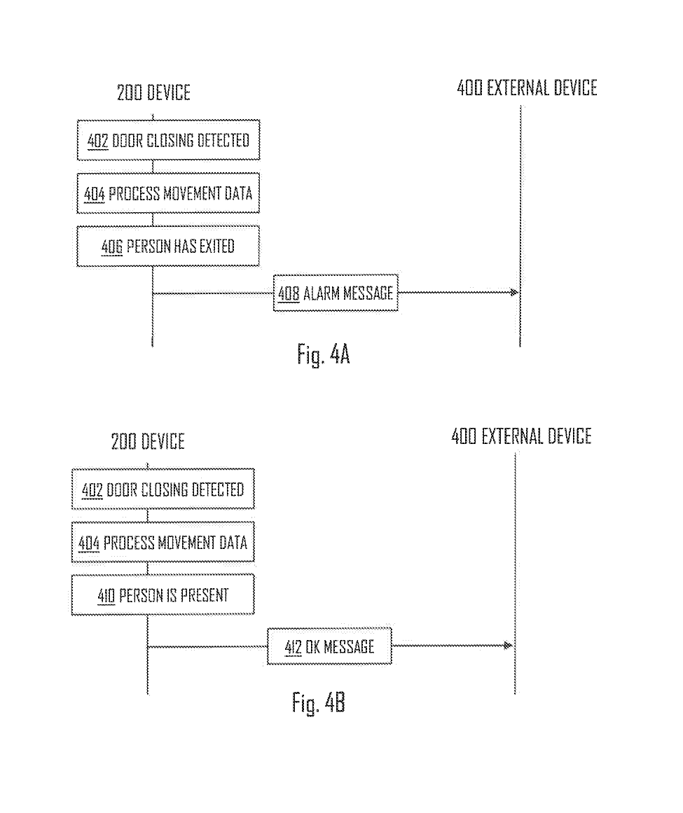

Let us now look at a flow diagram according to an embodiment of FIG. 3. Referring to FIG. 3, a method for detecting exit of a person from a room may be shown. In block 310, a computing device performing the detecting (e.g. the device 200 or the server computer 70) may determine whether or not a door closing is detected. If no door closing is detected, the computing device may continue the detecting exit of the person from the room (block 312). However, if the door closing is detected, the computing device may initiate processing of movement data from the movement detection means 250 (e.g. movement detection sensor(s)) (block 320). In block 330, the computing device may output a message concerning the processing of the measurement data.

In an embodiment, the computing device is the server computer 70. Thus, the blocks 310, 320, 330, 312 may be performed by the server computer 70. This may require that the device 200 transmits measurement data from the movement detection means 250 to the server computer 70. Further, the server computer 70 may receive data concerning the door opening and/or closing from the device 200. The block 330 may then comprise, for example, transmitting an alarm message, by the server computer 70, to an external device, such as the user device. 90. The block 330 may then comprise, for example, transmitting an alarm message (i.e. no movement detected from said measurement data), by the server computer 70, to an external device, such as the user device 90 or to the device 200. Thus, the server computer 70 may, if needed, cause a performing of an alarm. If movement is detected, the server computer 70 may, for example, inform the device 200 that the person is present in the room and/or that no alarm is required.

In an embodiment, the device 200 continuously or periodically transmits said measurement data to the server computer 70. Further, the server computer 70 may initiate processing of said measurement data only after the device 200 indicates detection of the door opening and closing or detection of the door closing. In this embodiment, more data may be transmitted, hut processing resources may still be saved.

In an embodiment, the device 200 transmits said measurement data to the server computer 70 only after detecting the door closing. Further, the server computer 70 may initiate processing of said measurement data only after said data is received from the device 200. In an embodiment, the device 200 continuously or periodically transmits measurement data both from the to movement detection means 250 and from the means for detecting door opening and closing to the server computer 70. The server computer 70 may then detect the door closing on the basis of the measurement data from means for detecting door opening and closing, and further process the measurement data from the movement detection means 250 only after detecting the door closing. This may also reduce processing power requirements of the system.

In an embodiment, the computing device is the device 200. Thus, the blocks 310, 320, 330, 312 may be performed by the device 200.

In an embodiment, the device 200 performs block 310. If no door closing is detected, the device 200 may continue the detection in block 312. If door closing is detected, the device 200 may start to transmit movement data form the movement detection means 250 to the server computer 70. The server computer 70 may then perform blocks 320, 330.

In an embodiment, the device 200 performs block 310. If no door closing is detected, the device 200 may continue the detection in block 312. If door closing is detected, the device 200 perform blocks 320, 330. In block 330, the device 200 may transmit one or more messages to the server computer 70. The one or more messages may comprise an alert message if the movement data indicates that the person has exited the room. The one or more messages may comprise a status message indicating that the person is still in the room if the movement data indicates that the person has not exited the room. In an embodiment, the one or more messages may comprise movement data. Thus, the server computer 70 may perform an action based on the movement data (e.g. output alert message if person has exited).

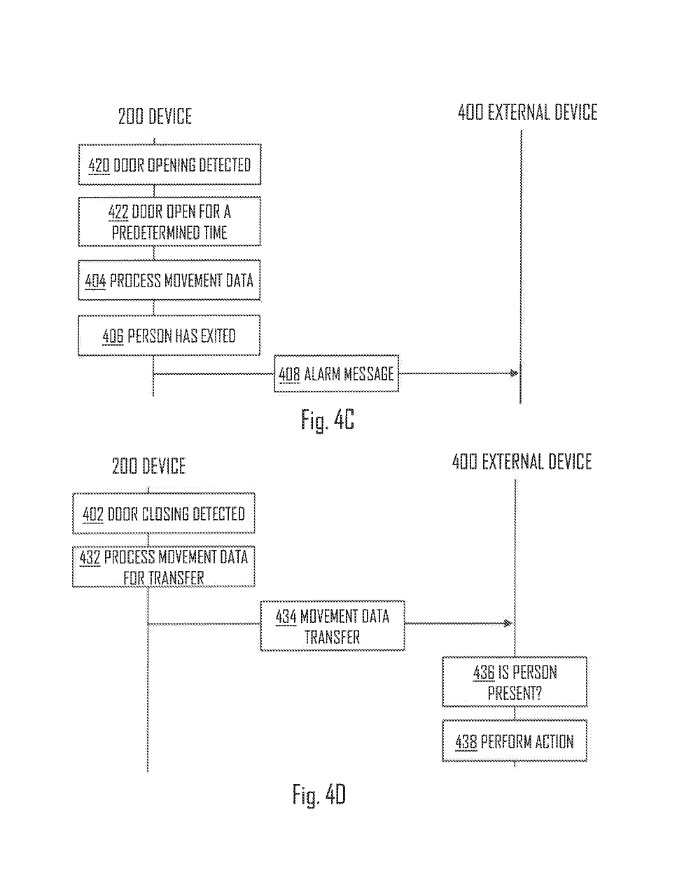

FIGS. 4A to 4D illustrate flow diagrams according to some embodiments. Referring to FIG. 4A, in block 402, the device 200 may detect the door closing (e.g. door is being closed from at least partial open state to closed state). This may initiate the processing of the movement data in block 404. In block 406, if the person has exited the room (i.e. detection based on the movement data), an alarm message 408 may be transmitted to an external device 400. The external device 400 may be the server computer 70 or the user device 90, for example. Thus, for example, a caretaker or relative may become aware if the person has exited the room.

In an embodiment, the device 200 outputs an alarm signal if the movement data indicates that the person has exited the room. The alarm signal may comprise visual, haptic and/or sound indication. In an embodiment, the device 200 outputs an alarm signal to the external device 400 if the movement data indicates that the person has exited the room. The alarm signal may cause a visual, haptic and/or sound indication. For example, the device 200 or some other device in the room or outside the room may comprise an alarm system for outputting the alarm.

In an embodiment, the processing circuitry 210 is configured to cause the output of the message if said movement data indicates that the person has exited the room. Said message may in this case indicate that the person has exited the room. Thus, for example, the server 70 may become aware that the person has exited the room and possibly perform actions, such as notify the user device 90 about the exit. As explained, the detecting that the user has exited the room may happen in the server 70 or in the device 200. If the server computer 70 performs the determination, the server computer 70 may transmit a signal to the device 200 causing the processing circuitry to cause the output of the message. However, as explained, the server computer 70 may not be required in all cases and thus the device 200 may perform the detection and the output of the message independently.

In an embodiment, the processing circuitry 210 is configured to cause the output of the message if said movement data indicates that the person has exited the room and has been out of the room for at least a predetermined time. The message may yet again indicate that the user has exited the room. The predetermined time may be, for example, 10 seconds, 15 seconds, 1 minute, 5 minutes or 10 minutes, to name a few examples. Thus, the movement data may be monitored and processed for the predetermined time. If the movement data indicates at any point that the person is present, the output of the message may not be performed. However, if the movement data does not indicate movement, the message may be outputted (e.g. alarm message to the server 70 or alarm message to the user interface 220 of the device 200 causing an output of an alarm). Such functionality may enable the person to go fetch his/her mail from a mailbox, for example. In other words, the device 200 may be configured to wait for a predetermined time before transmitting an alarm message. If during said predetermined time the movement data indicates movement, the transmission of the alarm message may be cancelled.

Referring to FIG. 4B, if the device 200 detects that the person is present (block 410) based on the movement data, the device 200 may transmit a status message to the external device 400 (block 412). The status message may indicate that the person is present or that everything is OK or that no alarm should be performed. Similarly, if the detection is performed by the server computer 70, the server computer 70 may indicate to the device 200 that the person is present and no alarm should be performed. In an embodiment, the processing circuitry 210 transmits or outputs a control message causing the processing circuitry 210 to stop the processing of the movement data. This may happen if the movement data does not indicate that the person has exited the room. This may mean that the processing circuitry 210 stops the processing of the movement data after a predetermined time or after the movement data indicates that the person is in the room.

In an embodiment, the processing circuitry 210 is further configured to initiate the processing of the measurement data from the movement detection means 250 as a response to detecting the door opening and the door remaining open for at least a predetermined time (e.g. 5 seconds, 10 seconds, 15 seconds, or 1 minute, to name a few examples). Example of this may be shown in FIG. 4C, wherein in block 420 the door opening is detected. In block 422, the device detects that the door has been open at least for the predetermined time. Thus, in block 404, the processing of the movement data may initiate. If the movement data indicates that the person has exited (e.g. no movement in the room; block 406), the message may be outputted. One example of this may be to transmit the alarm message to the external device 400 (block 408).

At this point it needs to be further pointed out that the processing of the movement data may mean several things. One is that the device 200 starts to monitor the movement data. By monitoring the movement data, the device 200 may detect if the person is present in the room or is not present in the room (i.e. has exited the room). For example, the device 200 may detect that the person is present if the movement data indicates movement in the room exceeding a threshold. For example, the device 200 may detect that the person is present if the movement data indicates any measured movement in the room.

In an embodiment, the processing circuitry 210 is configured to determine that the person is not in the room if detected movement in the room does not exceed a threshold.

On the other hand the processing of the movement data may mean processing the movement data for transfer as shown in block 432 of FIG. 4D. In block 434, the movement data or at least some movement data may be transferred to the external device 400. In block 436, the external device 400 may detect if the person is in the room or not. In block 438, the external device 400 may perform an action depending on the detecting in block 436. For example, if the movement data indicates that the user has exited the room, an alarm message may be transmitted to the device 200 and/or to the user device 90. For example, if the movement data indicates that the user has not exited the room, a message may be transmitted to the device 200 causing the device 200 to stop the movement data transfer.

In an embodiment, the device 200 comprises the wireless communication circuitry 230, wherein the processing circuitry is configured to cause the output of the message to the external device 400 via the wireless communication circuitry. In an embodiment, the device 200 comprises a wired connection to a network comprising the external device 400 or directly to the external device 400, wherein the message is transmitted via the wired connection to the external device 400.

In an embodiment, the device 200 transmits the message (e.g. alarm message) via the personal device $0 to the external device 90. Thus, for example, the device 200 may be connected to the personal device 80 via Bluetooth connection and the personal device 80 may be connected to a network via cellular connection. Thus, the personal device 80 may convey the message from the device 200 to the external device 400 (e.g. server computer 70 and/or the user device 90).

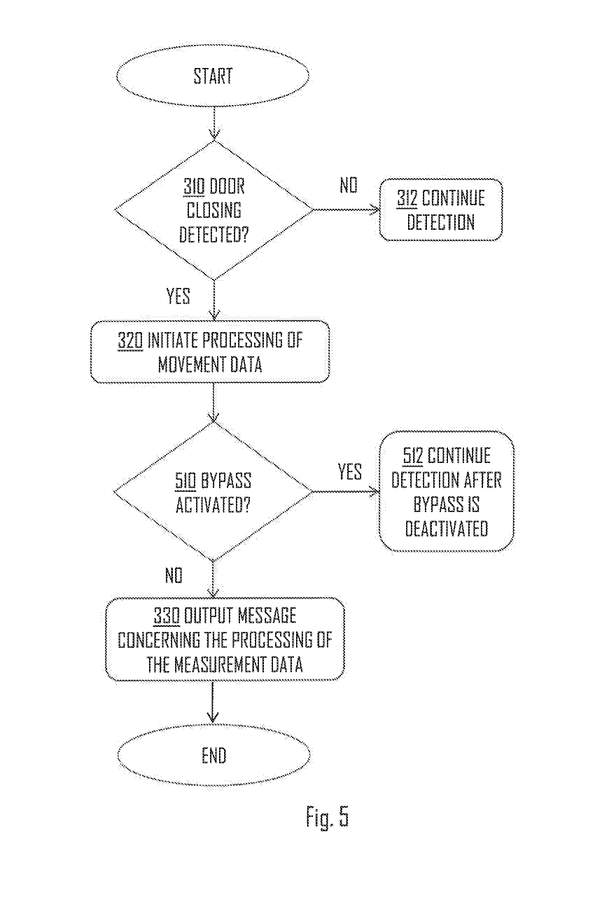

FIG. 5 illustrates a flow diagram according to an embodiment. The device 200 may comprise bypass means for preventing the output of the message. That is, the bypass means may enable preventing the output of an alarm message or output of the message(s) comprising movement data. Thus, even though the device 200 would determine a need to output the message, the bypass means may prevent this. In an embodiment, the bypass means comprise a circuitry that is a part of the processing circuitry 210. In other words, the processing circuitry 210 may comprise the bypass means or at least a part of the bypass means.

In an embodiment, the bypass means comprise a bypass switch configured to enable preventing the output of the message. The bypass switch may comprise a button in, on or at the device 200 for preventing the output of the message.

In an embodiment, the bypass means are configured prevent the output of the message as a response to obtaining a bypass signal from the external device 400 via the wireless communication circuitry 230. In an embodiment, the bypass means are configured to initiate scanning of bypass signals as a response to detecting the door opening. At least in these cases the bypass means may comprise a bypass circuitry configured to cause the processing circuitry to bypass the processing of the movement data and/or bypass the outputting of the message.

Let us discuss few examples of how the bypass means may function. One example is show in FIG. 5, wherein after detecting door closing, the device 200 may determine whether or not the bypass is activated. If it is, the device 200 may stop the processing of the movement data and/or data from the means 240, or prevent transmitting or outputting messages, such as alarm messages. If bypass is not activated, the process may continue to block 330.

In another example, the device 200 may determine before transmitting the alarm message whether or not the bypass is activated. If the bypass is activated, the alarm message may not be transmitted even though the movement data would indicate that the person has exited the room. If the bypass is not activated, the alarm message may transmitted if the movement data indicates that the person has exited the room.

As explained, the bypass may be activated or deactivated in various ways. One example is the bypass switch at the device 200. If the bypass switch is engaged, the bypass may be activated. Another example is the use of bypass signals. In an embodiment, the device 200 determines, before transmitting the alarm message, whether or not the user device 90 is within a predetermined connection range. If the user device 90 (e.g. radio tag or mobile phone) is within the predetermined connection rang, the bypass may be automatically engaged. In an embodiment, the device 200 determines, before transmitting the alarm message, whether or not the user device 90 is within a predetermined connection range. If the user device 90 (e.g. radio tag or mobile phone) is within the predetermined connection range, the device 200 may transmit a query message to the user device 90. The query message may cause a query on the user device 90 whether or not to bypass the output of the alarm message. The device 200 may then receive a response to the query message. If the response indicates that the bypass should be activated, no alarm message is outputted. If the response indicates that the bypass should not be activated, the alarm message is outputted if the movement data indicates that the person has exited the room.

Further, the device 200 may query a bypass permission from the server computer 70. For example, if a bypass signal is received from the user device 90 or from the bypass switch, the device 200 may transmit a bypass query to the server computer 70 in order to determine whether or not the bypass is valid. For example, the bypass signal may comprise an identifier which may be compared with valid bypass identifiers on the server computer 70. In an embodiment, the device 200 comprises the valid bypass identifiers.

In an embodiment, the device 200 activates the bypass if a bypass signal is received and the bypass signal comprises a valid bypass identifier. As explained the bypass identifier may be compared with a list of valid bypass identifiers on the device 200 or on the server computer 70. The list may comprise one or more valid bypass identifiers. For example, if the device 200 detects that the person has exited the room by utilizing the various means described above, the device 200 may perform the alarm (e.g. transmit alarm message to external device or cause a local alarm on the device 200). However, if the person is carrying or wearing his/her personal device 80 having a valid bypass identifier, the alarm may not be performed. Thus, for example, a dementia patient may be allowed to leave his/her room when he/she is wearing his personal device 80. The personal device 80 may be used to locate the patient using the mesh network, for example. However, if the patient is not wearing his/her personal device 80 having a valid bypass identifier, the alarm may be performed.

In one example, the person may activate the bypass by using the bypass switch. The device 200 may be configured to activate the bypass only if also a valid bypass identifier is received.

In an embodiment, the personal device 80 comprises a bypass identifier. The user device 90 may be used control the list of valid bypass identifiers on the device 200 or on the server computer 70, for example. Thus, for example, the bypass identifier may be valid on certain times of day (e.g. between 08:00 and 16:00) or certain days. Also, the user device 90 may be used to remove or add one or more bypass identifiers from the list of valid bypass identifiers. Further, the user device 90 or the personal device 80 may be used to control the bypass identifier on the personal device 80. Controlling may thus happen locally or via a network, for example.

In an embodiment, the device 200 is configured to detect if at least one person exits the room without a valid bypass identifier. That is, the room may be occupied by more than one person. One example of this may be a patient and a relative visiting the patient. The relative may have a device comprising a valid bypass identifier. Thus, when the relative leaves the room, no alarm should be performed. However, if both the relative and the patient leave the room, the device 200 performs the alarm if both the relative and the patient are not carrying a user device comprising a valid bypass identifier.

In an embodiment, the device 200 is configured to detect the door opening and transmit a query signal to an external device as a response to detecting the door opening, wherein the device 200 is further configured to obtain a bypass signal from said external device as a response to transmitting the query signal, and wherein the device 200 is configured to prevent the output of the message if said bypass signal is valid. The validity of the bypass signal from the external device may be checked from the server computer 70, for example. In another example, the device 200 comprises a list of valid bypass signals. Thus, the device 200 may check the validity of the bypass signal from the external device internally. For instance, the device 200 may normally initiate the alarm (e.g. transmit the alarm message) when the person is not detected to be within the room after the door closing. However, if a valid bypass signal is obtained, the alarm may be cancelled or prevented, as described above. Thus, if the person going out from the room has a device transmitting a valid bypass signal, no alarm should be initiated. However, if the person going out from the room has no device or a device transmitting an invalid bypass signal, the alarm should be initiated. For example, this may enable the person to leave the room when he/she is wearing his/her personal device that is configured to transmit the valid bypass signal. In an embodiment, the mesh network is configured to monitor the person after the person leaves the room. Thus, for example, the server computer 70 may acquire location information about the person also after when the person has exited the room.

In an embodiment, the query signals comprises a message according to Bluetooth specifications.

In an embodiment, the device 200 is configured to detect the door opening and to transmit a Bluetooth transmission to an external device as a response to detecting the door opening, wherein said Bluetooth transmission causes the external device to activate an application for preventing the output of the message. For example, the external device May be the personal device 80 or the user device 90. The application may be used to query whether or not the bypass should be activated on the device 200. If the user selects bypass on the external device, the external device may transmit a bypass signal (e.g. Bluetooth transmission) to the device 200. Thus, the device 200 may activate the bypass and thus no alarm should be outputted.

In an embodiment, the output of the alarm message causes an activation of one or more surveillance cameras. For example, the device 200 may transmit the alarm message to the server computer 70, wherein the server computer 70 causes activation of the one or More surveillance cameras. The camera feeds may be displayed on the user device(s) 90 (e.g. mobile phone, tablet or computer used by a nurse or other caretaker). In another example, the server 70 may transmit, if necessary, an alarm message to the one or more surveillance cameras.

In an embodiment, the output of the alarm message after detecting that the person has exited the room causes at least one of: sound alarm, visual alarm, haptic alarm. For example, the alarm may be outputted via the user device 90 or via an alarm system (e.g. siren(s), display(s)) in the room or in a building in which the room is located in. For example, the alarm may be outputted on a display of a control room for monitoring one or more persons or patients.

Let us now discuss the detecting the door opening and closing with reference to embodiments of FIGS. 6A to 6B. Referring to FIG. 6B, the door 22 may be open. Referring to FIG. 6B, the door 22 may be closed. In an embodiment, the means for detecting the door opening and closing comprise a magnetic sensor 602, 604 having a first and second parts, and wherein the first part is situated at a frame of the door 22 and the second part is situated at a leaf of the door 22.

In an embodiment, the first or the second part of the magnetic sensor comprises a magnetic switch 602, and wherein the first or the second part of the magnetic sensor comprises at least one magnet 604, the at least one magnet and the magnetic switch being situated in different parts of the magnetic sensor. As show in FIG. 6A, the magnetic switch 602 may located at the leaf of the door 22 and the at least one magnet 604 may situated at the frame of the door 22. However, the location may be vice versa such that the at least one magnet is situated at the door leaf and the magnetic switch is located at the frame of the door.

The magnetic sensor 602, 604 may function so that when the door is closed, the switch is activated and when the door is open the switch is deactivated. However, the magnetic sensor 602, 604 may also function so that when the door is closed, the switch is deactivated and when the door is open the switch is activated. The magnetic sensor may comprise a Hall Effect switch or a reed switch, for example.

In another embodiment, the means for detecting the door opening and closing comprise an electrical switch. The electrical switch may function, for example, so that when the door is closed, a closed circuit is formed between a first part at the door leaf and a second part at the door frame. Thus, the processing circuit 210 may detect the door opening and door closing.

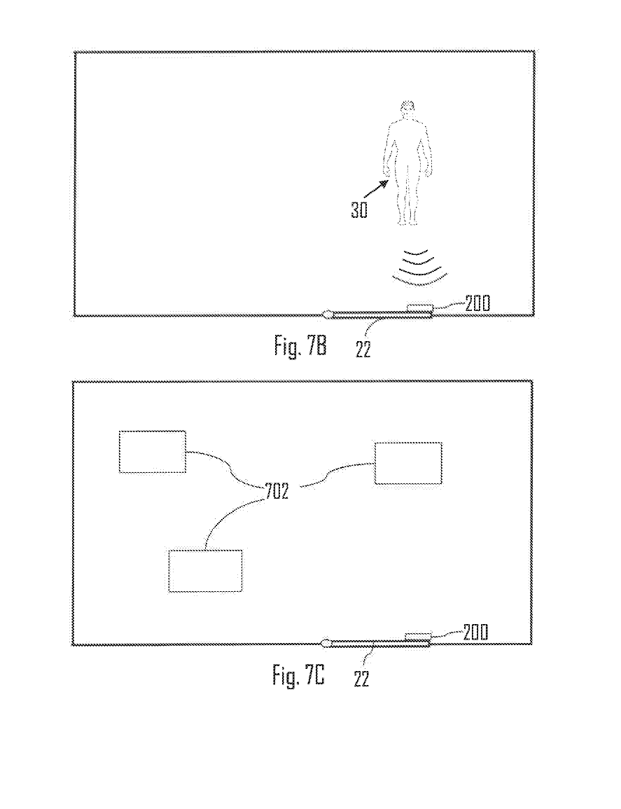

FIG. 7A illustrates an embodiment. Referring to FIG. 7A, the device 200 comprises attachment means for attaching the device to the door 22. The device 200 may be attached to the door leaf or to the door frame. The attachment means may comprise, for example, attachment with adhesive, such as glue. On the other hand, the device 200 may be attached to the door 22 using one or more fixing elements, such as screws. In an embodiment, the device 200 comprises attachment means for attaching the device to interior side of the door 22. Thus, the device 200 may be attached to face the room.

Looking at FIG. 7A, the function of the magnetic sensor 602, 604 may be further clarified. In an embodiment, the magnetic switch 602 is integral part of the device 200 whereas the at least one magnet 604 may be in a separate entity. The at least one magnet 604 may situated at the frame 26 of the door 22, for example.

FIG. 7B and 7C illustrate sonic embodiments. The movement detection means 250 of the device 200 may comprise a first sensor for detecting movement in the room. The first sensor may be an integral part of the device 200 or comprised in the device 200, for example. The first sensor may measure movement in the room. The movement in the room mean refer to movement inside the room and also in the doorway of the room when the door is open. Thus, in some embodiments, the first sensor may be used to detect movement only in the doorway area. In such case, the first sensor may be attached to the door such that it measures movement parallel to the doorway, for example. Example of this may be shown in FIG. 7D, wherein the sensor 720 may measure movement in the doorway.

In an embodiment, with reference to 7D, the device 200 comprises a first sensor for a first sensor 710 for detecting movement in the room and a second sensor 720 for detecting movement in a doorway of the room. This way, the device may use movement data from two sensors to determine whether or not the person has exited the room.

In an embodiment, the processing circuitry 210 is further configured to initiate processing of measurement data from said first sensor 710 as a response to detecting the door opening, then detecting based on measurement data from the second sensor 720 that the user moves in the doorway and then detecting the door closing. Thus, the further requirement for initiating the processing of the measurement data from said first sensor 710 may be that the measurement data from the second sensor 720 indicates that the user has moved in the doorway. This may even further increase the benefits of the invention, such as lower power consumption.

Referring to FIG. 7B, the movement by the person in the room may be detected by the movement detection means 250 of the device 200. For example, if the movement detection means 250 indicate movement in the room, no alarm may be performed. However, if no movement is detected, the alarm may be performed. In the case that the movement detection means 250 only measure movement in the doorway, the detected movement in the doorway may indicate that the user has exited the room. By using two sensors 710, 720, the first sensor 710 may be further used to detect movement in the room after the second sensor 720 has detected movement in the doorway. Thus, the reliability of the measurement may be enhanced. If the second sensor 720 indicates movement and the first sensor 710 does not indicate movement, the device 200 or the processing circuitry 210 may determine that the person has exited the room. Alarm may be performed if bypass is not activated.

In an embodiment, with reference to FIG. 7D, the processing circuitry 210 is configured to detect movement direction of an object from the measurement data for the first and second sensors 710, 720. Thus, it may be detected whether the object is leaving or entering the room. In case of entering the room, no alarm is initiated by the device 200. In case of leaving the room, alarm may be initiated by the device 200 depending on other factors, such as bypass activation. The movement direction may be detected from a sequence of movement detection by the first and second sensors 710, 720. For example, if first movement is detected with the second sensor 720 and then with the first sensor 710, the object is moving into the room.

In an embodiment, the processing circuitry 210 is configured to detect door opening. Detecting door opening may initiate processing of the movement data from both the first and second sensors 710, 720. Thus, the movement direction may be determined by the device 200 and an alarm may be performed if necessary.

Referring to FIG. 7C, the room may have a plurality of objects 702 other than the person 30. In order to limit false movement detection, the movement detection means 250 may comprise one or more sensors configured to detect movement or motion. Said sensor(s) may comprise optical proximity sensor(s), camera(s), and/or passive infrared (PIR) sensor(s), for example. Thus, for example, presence of furniture may be ignored.

In an embodiment, the movement detection means 250 comprise at least one PIR sensor. For example, the first and/or second sensors 710, 720 may be PIR sensors. The PIR sensor may be configured to detect movement in a monitoring area. The PIR sensor may segment the monitored area into a plurality of segments. The PIR sensor may detect if an entity, such as the person, changes position between the segments. Thus, movement may be detected and an alarm may be performed if necessary.

In an embodiment, the at least one PIR sensor is configurable by the processing circuitry 210. For example, the processing circuitry 210 may configured sensitivity of the at least one PIR sensor. For example, the number of segments may be changed. The more there are segments, the more sensitive the PIR sensor may be (e.g. smaller movement may cause the alarm). The at least one PIR sensor may comprise a lens, wherein the lens may determine the dimensions of the monitored area, 1.e, the characteristics of the lens may determine how wide or tall the observed area is. Thus, the lens may be used to configure the PIR sensor to detect movement from a desired monitoring area.

In an embodiment, the movement detection means 250, such as the at least one PIR sensor, are configured to detect movement in a monitoring area. The monitoring area may be a sub-part of the room. Thus, the whole room may not necessarily be monitored. For example, the monitoring area may be configured such that it does not reach floor level of the room. This may reduce false measurements caused by pets, for example.

Thus, in an embodiment, the movement detection means 250 are configured to detect movement occurring at least a predetermined distance above floor level. The predetermined distance may be, for example, 10 cm, 15 cm, 20 cm, 30 cm, 50 cm or one meter. Similar logic may apply, at least in some embodiment, to ceiling, as there may be no need to detect movement near the ceiling of the room.

In an embodiment, the movement detection means 250 are configured to detect movement occurring within a predetermined distance from the movement detection means 250 (e.g. from a predetermined distance from a particular movement detection sensor). The predetermined distance may be, for example, 50 cm, one meter, two meter or three meters. Thus, movement relatively close to the door may be detected. In some embodiments, restricting the movement detection above the floor level may also apply. Thus, for example, movement happening one meter above the floor level and within two meters of the movement detection means 250 may be detected.

In an embodiment, the movement detection means 250 are configured to ignore movement occurring outside the monitoring area. In an embodiment, the movement detection means 250 are configured to detect movement within a sub-area of the monitoring area. For example, a sub-group of the plurality of segments of the monitoring area are monitored. Thus, for example, segments close to the floor level may be ignored.

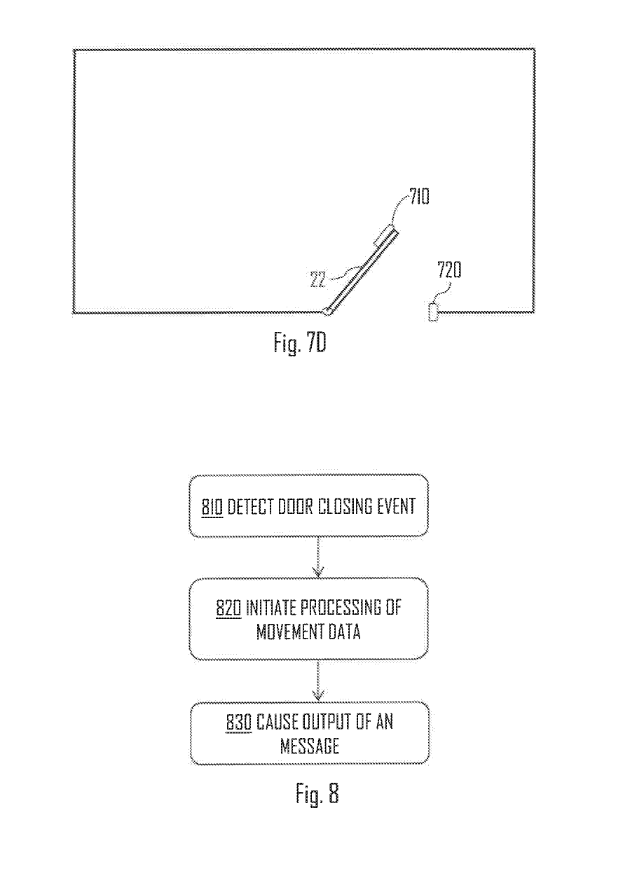

FIG. 8 illustrates a flow diagram according to an embodiment. FIG. 8 shows a method for detecting exit of a person from a room. Referring to FIG. 8, an apparatus, such as the device 200 or the server computer 70, detects a door closing event (e.g. detect door closing as described above). As a response to the detecting the door closing event, the apparatus may initiate processing of measurement data from one or more movement detection sensors 710, 720. Further, the apparatus may cause an output of a message concerning the processing of said measurement data. Thus, for example, if the person is not present in the room according to said measurement data, the apparatus, e.g. the device 200, may transmit a message to the server computer 70 indicating that the person has exited the room. Other examples of what the message may comprise are described in detail above, such as transmitting measurement data, transmitting status OK message or transmitting a message (e.g. signal to stop the processing.

In an embodiment, the device 200 is implemented on a System-on-Chip (SoC) circuitry. This may provide a cost-friendly way to implement the functions of the device 200 with software on a single circuitry.

In an embodiment, the device 200 is configured to retransmit the message (e.g. message of blocks 330, 408 or 412). For example, if there is problems with network connectivity, the device 200 may retransmit the message. For example, the alarm message of block 408 may be retransmitted for as long as a response is received from the server computer 70. Similar logic may apply to all message transmitted by the device 200 to the server computer 70. For example, the device 200 may retransmit the alarm message as long as a user input (e.g. via air-interface or via user interface at the device 200) is obtained requesting to stop the transmission of the alarm message.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 1 to 8 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 1 to 8 or operations thereof.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 1 to 8, or operations thereof.

The techniques and methods described herein may be implemented by various means. For example, these techniques may be implemented in hardware one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1 to 8 may be carried out by executing at least one portion of a computer program comprising corresponding instructions. The computer program may be in source code form, object code form, or in sonic intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, to telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A device for detecting exit of a person from a room, the device comprising:
a casing;
a detector for detecting door opening and closing, said detector being enclosed by the casing;
movement detector for detecting movement in the room, the casing further enclosing the movement detector such that movement detector and the detector for detecting door opening and closing are both situated in the same device; and
a processing circuitry configured to initiate processing of measurement data from the movement detector as a response to detecting the door closing, and to cause an output of a message concerning the processing of said measurement data.

2. The device of claim 1, wherein the processing circuitry is configured to cause the output of the message if said movement data indicates that the person has exited the room.

3. The device of claim 2, wherein the processing circuitry is configured to cause the output of the message if said movement data indicates that the person has exited the room and has been out of the room for at least a predetermined time.

4. The device of claim 1, further comprising:
a wireless communication circuitry for enabling wireless communication with an external device, wherein the processing circuitry is configured to cause the output of the message to the external device.

5. The device of claim 4, wherein said message comprises at least some measurement data from the movement detector.

6. The device of claim 1, wherein the processing circuitry is further configured to initiate the processing of the measurement data from the movement detector as a response to detecting the door opening and the door remaining open for at least a predetermined time.

7. The device of claim 1, further comprising:
bypass circuitry for preventing the output of the message.

8. The device of claim 7, wherein the bypass circuitry comprises a bypass switch configured to enable preventing the output of the message.

9. The device of claim 7, wherein the bypass circuitry is configured to prevent the output of the message as a response to obtaining a bypass signal from an external device via the wireless communication circuitry.

10. The device of claim 9, wherein the bypass circuitry is configured to initiate scanning of bypass signals as a response to detecting the door opening.

11. The device of claim 7, wherein the device is configured to detect the door opening and to transmit a query signal to an external device as a response to detecting the door opening, wherein the device is further configured to obtain a bypass signal from said external device as a response to transmitting the query signal, and wherein the device is configured to prevent the output of the message if said bypass signal is valid.

12. The device of claim 1, wherein the detector for detecting the door opening and closing comprises a magnetic sensor having a first and second parts, and wherein the first part is situated at a frame of the door and the second part is situated at a leaf of the door.

13. The device of claim 12, wherein the first or the second part of the magnetic sensor comprises a magnetic switch, and wherein the first or the second part of the magnetic sensor comprises at least one magnet, the at least one magnet and the magnetic switch being situated in different parts of the magnetic sensor.

14. The device of claim 1, wherein the movement detector comprises a first sensor for detecting movement in the room and a second sensor for detecting movement in a doorway of the room.

15. The device of claim 14, wherein the processing circuitry is further configured to initiate processing of measurement data from said first sensor as a response to detecting the door opening, then detecting based on measurement data from the second sensor that the user moves in the doorway and then detecting the door closing.

16. The device of claim 1, wherein the movement detector comprises at least one passive infrared sensor.

17. A method for detecting exit of a person from a room, the method comprising:
detecting, by a device using a switch enclosed by a casing of the device, a door closing event;
as a response to the detecting the door closing event, initiating processing of measurement data from one or more movement detection sensors enclosed by said casing of the device; and
causing an output of a message concerning the processing of said measurement data.
